(19) United States
(12) Patent Application Publication
(10) Pub. No.: US 2013/0138456 A1
(43) Pub. Date: May 30, 2013

(54) SYSTEM AND METHOD FOR PROVIDING STAKEHOLDER SERVICES

(71) Applicant: GENERAL ELECTRIC COMPANY, Schenectady, NY (US)

(72) Inventors: Tarun Bhaskar, Bangalore (IN); Gopi Subramanian, Bangalore (IN); Arokiaswamy Thangaprabhu, Bangalore (IN)

(73) Assignee: GENERAL ELECTRIC COMPANY, Schenectady, NY (US)

(21) Appl. No.: 13/683,709

(22) Filed: Nov. 21, 2012

(30) Foreign Application Priority Data
Nov. 24, 2011 (IN) 4059/CHE/2011

(51) Int. Cl. G06Q 50/24

(52) U.S. Cl. CPC G06Q 50/24
USPC 705/3

(57) ABSTRACT

A system and method for providing stakeholder services is provided. The system, comprises a data repository, comprising historical health records and socio-economic condition records of a plurality of patients, and a plurality of processing subsystems that are operationally coupled to the storage device, wherein the plurality of processing subsystems comprise two or more service modules that are configured to provide selective stakeholder services to one or more of a plurality of stakeholders based upon a plurality of parameters.

### BACKGROUND OF THE INVENTION

Embodiments of the present invention relate to healthcare systems, and more particularly to health record maintenance systems and methods. The quality of healthcare is generally a function of many factors including precise and timely information about a patient's medical history. In developing and underdeveloped nations, the quality of healthcare additionally depends upon other factors, such as, the financial condition of a patient. The standard of living and other social and family related information are important in these regions. For example, a poor and illiterate patient located in a rural or suburban area may not have access to healthcare services due to the cost of such services. Therefore, a patient's medical history alone may not be enough to offer timely treatment at a reasonable cost.

The healthcare service providers maintain medical records of patients in a stand-alone paper based form or a digital form. Ironically, the patients may not have access to the medical records (paper form or digital form) that are maintained by the healthcare service providers. Furthermore, when the patients are referred to or move to other healthcare service providers, the other healthcare service providers do not have access to health records of the patients maintained by the earlier healthcare service providers. In addition, the medical records that are maintained by the earlier healthcare service providers may be destroyed after a certain time period. Moreover, the patients typically receive paper based medicine prescriptions or medical test reports. However, such paper based records received by the patients have negligible information on their past illness, diagnosis and treatment. Additionally, patients may be incapable of describing respective health history, health problems, past diagnosis results and details of earlier healthcare service providers. Consequently, healthcare service providers and patients have minimal information of past health records of the patients. Certain healthcare service providers maintain digital records as electronic medical records (EMR). However, the development and maintenance of the electronic medical records is expensive, and are not accessible to patients and/or other healthcare service providers.

The healthcare sector involves different stakeholders that play respective roles at different levels of diagnosis and treatment. For example, a primary care center is a first point of consultation for a patient. The primary care center may include a primary care physician, a general practioner, a family physician, and the like. The primary care center deals with the widest scope of health care including all ages of patients, patients of all socioeconomic and geographic origins, patients seeking to maintain optimal health, and patients with all manner of acute and chronic physical, mental and social health issues, including multiple chronic diseases. However, secondary care centers and tertiary care centers provide specialized healthcare services by medical specialists and other healthcare professionals who generally do not have first consultation with patients, for example, cardiologists, urologists and dermatologists. Therefore, based upon the different levels of diagnosis and treatment levels and roles of the stakeholders, the stakeholders may require selective medical records of patients. However, as previously noted, the medical records of patients are generally maintained as standalone records by healthcare service providers, reducing or eliminating the possibility of selective historical healthcare records.

### BRIEF DESCRIPTION OF THE INVENTION

According to an embodiment of the present invention, a healthcare system is provided. The system comprises a data repository comprising historical health records and socio-economic condition records of a plurality of patients, and a plurality of processing subsystems that are operationally coupled to the storage device, wherein the plurality of processing subsystems comprise two or more service modules that are configured to provide selective stakeholder services to one or more of a plurality of stakeholders based upon a plurality of parameters.

### BRIEF DESCRIPTION OF THE DRAWINGS

These and other features and aspects of embodiments of the present invention will become better understood when the following detailed description is read with reference to the accompanying drawings in which like characters represent like parts throughout the drawings, wherein:

FIG. 1 is a diagrammatic illustration of an exemplary healthcare record system for maintaining portable historical health records and socio-economic condition records of a plurality of patients, in accordance with embodiments of the present systems and techniques;

FIG. 2 is a diagrammatic illustration of the health records and socio-economic condition records referred to in FIG. 1, in accordance with an exemplary embodiment of the present systems and techniques;

FIG. 3 is a diagrammatic illustration of a health card referred to in FIG. 1, in accordance with an exemplary embodiment of the present systems and techniques;

FIG. 4 is a flow chart that illustrates an exemplary method for registering a patient with a plurality of processing subsystems referred to in FIG. 1, in accordance with embodiments of the present techniques;

FIG. 5 is a diagrammatic illustration of service modules that offer selective services to stakeholders referred to in FIG. 1, in accordance with an exemplary embodiment of the present systems and techniques;

FIG. 6 is a flow chart that illustrates an exemplary method for generating statistical and analytical results by the healthcare service provider module referred to in FIG. 5, in accordance with an exemplary embodiment of the present systems and techniques; and

FIG. 7 is a flow chart that illustrates an exemplary method for predicting a potential number of patients in a region by the government service module referred to in FIG. 5, in accordance with embodiments of the present systems and techniques.

### DETAILED DESCRIPTION OF THE INVENTION

As discussed in detail below, embodiments of the present systems and techniques provide a portable health record system that enables a plurality of patients to have ownership and access of respective detailed patient records including, but not limited to, historical health records and socio-economic condition records. Certain embodiments of present systems and techniques provide a plurality of processing subsystems that have a cloud computing architecture. The processing subsystems collect and maintain the historical health records and socio-economic condition records of the patients. The processing subsystems maintain the historical health records and socio-economic condition records of the patients in a layered data structure format. The layered data structure format enables grant of varied and flexible rights on the historical health records and the socio-economic condition records to different stakeholders in a healthcare system. The rights, for example, may include accessing, updating and reviewing rights over the historical health records and socio-economic condition records of the patients.

Furthermore, in certain embodiments, the layered data structure format enables display of a subset of the historical health records and socio-economic condition records in a varied sequence based upon the level and role of a stakeholder accessing the historical health records and socio-economic condition records. In certain other embodiments, the present systems and techniques enable stakeholders to access a desired subset of the historical health records and socio-economic condition records of a patient. Therefore, the present systems and techniques provide control to the stakeholders to access a desired subset of the historical health records and socio-economic condition records in a desired sequence.

In certain embodiments, the processing subsystems include a plurality of healthcare modules that offer stakeholder services to the stakeholders. As used herein, the term “stakeholder services” refers to services that are offered to stakeholders by the present systems and techniques. As used herein, the word “stakeholder” refers to a participant in the healthcare network. The stakeholders, for example, may include healthcare service providers, government, healthcare workers and patients. The healthcare service providers, for example, may be a primary care center, a secondary care center, a tertiary care center, a hospital, a clinic, an independent physician, a doctor, a healthcare insurance provider, and the like. The processing subsystems provide the stakeholder services by accessing, analyzing, and reviewing the historical health records and socio-economic condition records of the patients.

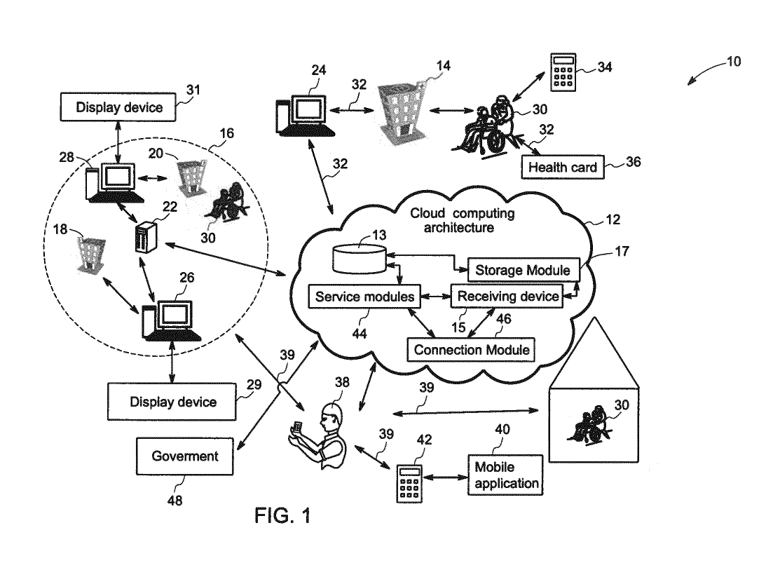

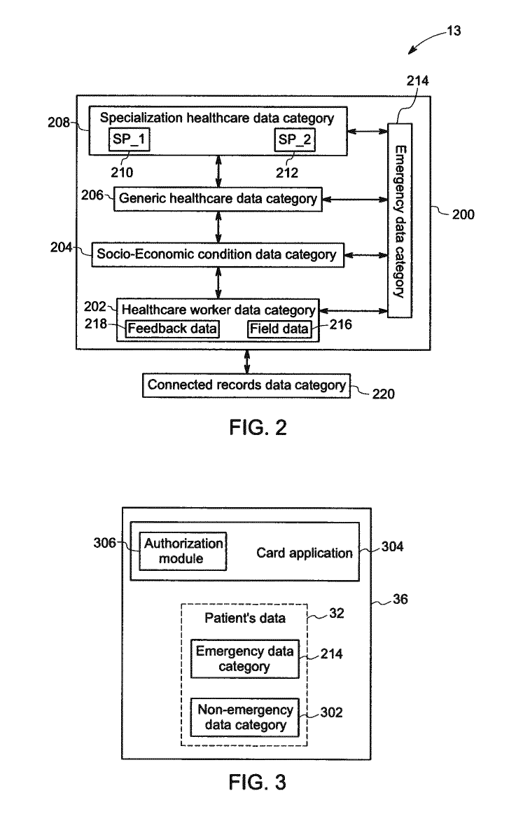

FIG. 1 is a diagrammatic illustration of an exemplary healthcare record system 10 for maintaining portable patient records such as historical health records and socio-economic condition records of a plurality of patients. The healthcare record system 10 further provides selective stakeholder services to different stakeholders. The healthcare record system 10 includes a plurality of processing subsystems 12 that store the patient records 13, including historical health records and socio-economic condition records of a plurality of patients 30. The processing subsystems 12 store the historical health records and socio-economic condition records 13 of the plurality of patients 30 in a layered data structure format. The layered data structure format is explained in greater detail with reference to FIG. 2.

As shown in FIG. 1, the healthcare record system 10 includes a plurality of healthcare service providers 14, 16. In the presently contemplated configuration, the healthcare service provider 16 is a group or chain of healthcare service providers located at remote locations. In the presently illustrated configuration, the group of healthcare service providers 16 includes a first healthcare service provider 18 and a second healthcare service provider 20. Each of the healthcare service providers 14, 18, 20 has a respective healthcare service provider's (HSP) processing subsystems 24, 26 28, respectively. In the presently contemplated configuration, the HSP processing subsystems 26, 28 are operationally coupled to a server 22. The HSP processing subsystems 26, 28 may be coupled to the server 22 via a wired connection or a wireless connection. In an embodiment, the HSP processing subsystems 26, 28 may be coupled to the server 22 via intranet, internet or a local area network. Furthermore, the server 22 and the HSP processing subsystem 24 are operationally coupled to the processing subsystems 12. The server 22 and the HSP processing device 24 may be coupled to the processing subsystems 12 via a wired connection or a wireless connection. In certain embodiments, the server 22 and the HSP processing device 24 may be coupled to the processing subsystems 12 via internet.

When the patient 30 reaches the healthcare service provider 14, the healthcare service provider 14 may verify from the patient 30 whether the patient 30 has been registered with the processing subsystems 12. In alternative embodiments, the healthcare service provider 14 may verify from the processing subsystems 12 whether the patient 30 has been registered with the plurality of processing subsystems 12. The healthcare service provider 14, for example, may obtain verification from the processing subsystems 12 by inserting a unique identification number or name of the patient in the processing subsystems 12 through the HSP processing subsystem 24. The healthcare service provider 14 may verify the registration of the patient 30 via biometric methods. In the presently contemplated configuration, the healthcare service provider 14 determines that the patient 30 has not been registered with the processing subsystems 12. Therefore, the healthcare service provider 14 registers the patient 30 with the processing subsystems 12 through the respective HSP processing subsystem 24.

While registering the patient 30 with the processing subsystems 12, the healthcare service provider 14 submits the patient data 32 into the processing subsystems 12. The patient data 32, for example, may include emergency data and non-emergency data of the patient 30. As used herein, the term “non-emergency data” refers to healthcare records that may or may not be required during an emergency condition of a patient. The non-emergency data, for example includes socio-economic condition records, health problems, historical health records, date of medical prescription, and the like of the patient 30.

The processing subsystems 12 receive the patient data 32 via a receiving device 15. The processing subsystems 12 may process the received patient's data 32 to store the patient's data 32 in the historical health records and socio-economic condition records 13. In certain embodiments, the processing subsystems 12 may include a storage module 17 that is operationally coupled to the receiving device 15. The storage module 17 may process the received patient data 32 to store the patient data 32 in the historical health records and socio-economic condition records 13. The storage module 17 processes the patient data 32 to store the patient data 32 in the layered data structure format of the historical health records and socio-economic condition records 13. It is noted that since the processing subsystems 12 have a cloud computing architecture, the HSP processing subsystem 24 does not require data storage capacity for storing the patient data 32. The patient data 32 shall be explained in greater detail with reference to FIG. 2 and FIG. 3. It is noted that in certain embodiments, the patient data 32 of the patient 30 may be exactly similar to historical health records and socio-economic condition records corresponding to the patient 30 in the processing subsystems 12. In alternative embodiments, the patient data 32 may be a subset of the historical health records and socio-economic condition records corresponding to the patient 30 stored in the processing subsystems 12. As previously noted, the layered data structure format provides various advantages to the stakeholders.

In an embodiment, when the patient 30 is registered with the processing subsystems 12, the patient 30 receives respective registration details including a unique patient identification number on respective mobile devices 34. Furthermore, the healthcare service provider 14 provides a health card 36 to the patient 30 that includes the patient's data 32. The health card 36 is explained in greater detail with reference to FIG. 3. During the diagnosis and treatment process of the patient 30, the healthcare service provider 14 updates the patient data 32 for the patient to include date of diagnosis, date of treatment, date of health/medical checkup, diagnosed condition or disease, suggested treatment, suggested medical checkups and medicines, and the like. The patient data 32, for example, may be updated in the health card 36. Additionally, the healthcare service provider 14 updates the historical health records and socio-economic condition records 13 to include updations in the patient data 32. It is noted that the healthcare service provider 14 updates the patient data 32 in the health card 36 and the historical health records and socio-economic condition records 13 via the respective HSP processing subsystems 24. It is noted that since the plurality of processing subsystems 12 have a cloud computing architecture, the operating system and hardware configuration of the HSP processing subsystem 24 is independent of the operating system and hardware configurations of the HSP processing subsystems 12. Additionally, it is noted that while the presently illustrated configuration includes the processing subsystems 12 that have a cloud computing architecture, in certain embodiments, the processing subsystems 12 may act as a server, and the HSP processing subsystems 24, 26, 28 may act as client to form a client-server architecture.

The patient 30 owns the health card 36, and therefore, the patient 30 may access the patient data 32 in any processing device irrespective of the operating system of the processing device. Furthermore, when the patient 30 moves or is referred to another healthcare service provider 16, the patient 30 may offer the health card 36 to the healthcare service provider 16. The healthcare service provider 16 may access the patient data 32 in respective HSP processing subsystems 26, 28 after authorization of the patient 30. The authorization of the patient 30, for example, may include submission of a password by the patient 30. In alternative embodiments, the healthcare service provider 16 may retrieve historical health records and socio-economic condition records corresponding to the patient 30 from the processing subsystems 12. The historical health records and socio-economic condition records corresponding to the patient 30, for example, may be displayed on display devices 29, 31 that are operationally coupled to the HSP processing devices 26, 28, respectively. Consequently the healthcare service provider 16 may access the patient's data 32 using the health card 36 or historical health records and socio-economic condition records corresponding to the patient 30 from the processing subsystems 12.

Additionally, the healthcare service provider 16 may provide timely and precise treatment to the patient 30 after analysis of the patient data 32 or the historical health records and socio-economic condition records corresponding to the patient 30. In certain embodiments, when the patient 30 does not carry the health card 36 and/or a healthcare service provider does not have a processing subsystem, the patient 30 may receive historical health records and socio-economic condition records corresponding to the patient 30 from the processing subsystems 12 on transmission of a message from the respective mobile device 34 to the processing subsystems 12. The processing subsystems 12 may transmit the historical health records and socio-economic condition records of the patient 30 on receipt of the message from the mobile device 34. In other embodiments, the patient 30 may provide unique identification number, name, or other details to the healthcare service provider 14. The healthcare service provider 14 may retrieve the historical health records and socio-economic condition records of the patient 30 from the processing subsystems 12 based upon the unique identification number, name, or other details. The healthcare service provider 14 may retrieve the historical health records and socio-economic condition records after due authorizations from the patient 30. It is noted that the patient's data 32 of the patient 30 may be a subset of the historical health records and socio-economic condition records corresponding to the patient stored in the processing subsystems 12. In certain embodiments, the patient's data 32 stored in the health card 36 may be similar to the historical health records and socio-economic condition records corresponding to the patient 30 stored in the processing subsystems 12.

The healthcare record system 10 further includes at least one healthcare worker 38. The healthcare worker 38 has a mobile application 40 on a mobile device 42 of the healthcare worker 38. The mobile application 40 enables the healthcare worker 38 to transmit field data and feedback data 39 of the patient 30 collected by the healthcare worker 38 to the healthcare service providers 14, 16, 18 or the processing subsystems 12. The field data and feedback data 39 are explained in greater detail with reference to FIG. 2. Particularly, the mobile application 40 transmits the field data and feedback data 39 to the server 22 or the HSP processing subsystems 24, 26, 28 of the healthcare service providers 14, 16, 18, and 20. The healthcare service providers 14, 16, 18, and 20 may access the field data and feedback data 39 through respective HSP processing subsystems 24, 26, 28. As used herein, the term “field data” refers to data related to health and socio-economic conditions of a patient or family members of the patient by a healthcare worker. Furthermore, as used herein, the term “feedback data” refers to data that includes feedback collected by a healthcare worker. The feedback data, for example, may include details on whether the patient 30 followed a medical prescription, present health status of the patient 30, present financial status of family members of a patient, any other factors that may impact the health of the patient, experience of the patient 30 with the healthcare service provider 14, or the like. In certain embodiments, the mobile application 40 may transmit the field data and feedback data 39 to a determined e-mail identification (ID) or the mobile device 34 of the patient 30. In certain other embodiments, the mobile application 40 may transmit the field data and feedback data 39 to determined e-mail IDs of the healthcare service providers 14, 16, 18, and 20. Subsequently the healthcare service providers 14, 16, 18, 20 may update the historical health records and socio-economic condition records 13 to include the field data and feedback data 39. In other embodiments, the mobile application 40 may transmit the field data and feedback data 39 to determined e-mail ids of the processing subsystems 12.

In certain embodiments, the processing subsystems 12 include a connection module 46 that connects historical health records and socio-economic condition records of a patient to historical health records and socio-economic condition records of the family members of the patient. The connection module 46, for example, may connect historical health records and socio-economic condition records of a patient to historical health records and socio-economic condition records of the family members of the patient based upon socio-economic conditions data that may include family details of the patient.

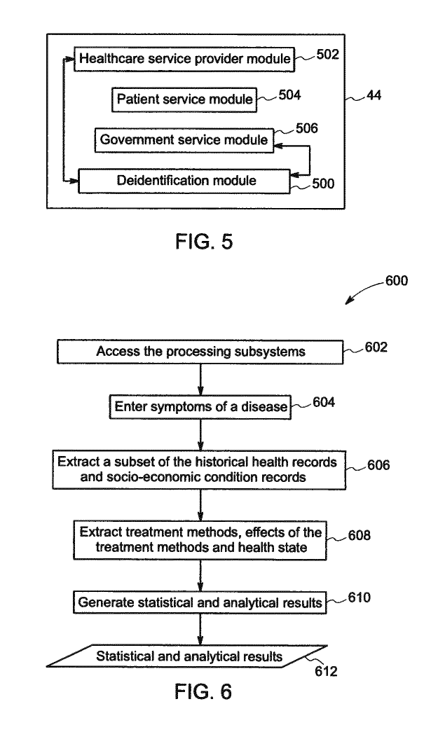

Furthermore, the processing subsystems 12 include a plurality of modules 30 that provide selective stakeholder services to stakeholders. In the presently contemplated configuration, the stakeholders include the healthcare service providers 14, 16, 18, 20, patient 30, healthcare worker 38 and government 44. For example, the healthcare service providers 14, 16, 18, 20 may have access to stakeholder services that enable the healthcare service providers 14, 16, 18, 20 to access, review and update certain portions of the historical health records and socio-economic condition records 13. However, the government 44 may be provided stakeholder services that generate statistical and analytical healthcare results for a determined region. The statistical and analytical results may be useful for planning and budgeting for a particular region. The service modules 44 are explained in greater detail with reference to FIG. 5.

FIG. 2 is a diagrammatic illustration of the health records and socio-economic condition records 13 in FIG. 1. In accordance with an exemplary embodiment, FIG. 2 shows a layered data structure 200 of the historical health records and socio-economic condition records 13. As shown in FIG. 2, the layered data structure 200 includes four data categories including a healthcare worker data category 202, a socio-economic condition data category 204, a generic healthcare data category 206 and a specialization healthcare data category 208. As used herein, the term “healthcare worker data category” refers to data that includes field data 216 and feedback data 218 collected by a healthcare worker, such as, the healthcare worker 38. As previously noted, the term “field data” refers to data related to health and socio-economic conditions of a patient or family members of the patient that is collected by a healthcare worker. The field data 216, for example, may include a name of a patient, a number of family members in the patient's family, socio-economic details of the patient and family members of the patient, health problems of the patient, symptoms shown by the patient, allergies of the patient, or the like. Since healthcare workers generally are not doctors, the field data 216 may include general health problems as communicated by a patient or a family member of the patient to the healthcare worker. The term “feedback data” refers to data that includes feedback of a patient collected by a healthcare worker. The feedback data 218, for example, may include details on whether a patient followed a medical prescription, present health status of the patient, present financial status of family members of a patient, any other factors that may impact the health of the patient, side action or reaction of a prescribed medicine, or the like.

Additionally, the layered data structure 200 includes the socio-economic condition data category 204. Furthermore, as used herein, the term “socio-economic condition data category” is used herein to refer to data that includes socio-economic condition records and geographic origin records of a patient. The socio-economic condition data category 204, for example, may include income of a patient, income of the family members of the patient, number of members in the family, expenditure of the family, financial status as per government guidelines, such as, below poverty line (BPL) or above poverty line (APL), savings, availability of income security, availability of insurance, availability of any government funded healthcare programs, insurance, family disease history, geographical origin, healthcare quality in a patient's region, and the like.

The layered data structure 200 further includes the generic healthcare data category 206. As used herein, the term “generic healthcare data category” refers to generic healthcare data records of a patient that are required by generic healthcare service providers. For example, generic healthcare data category includes healthcare data records of patients that are required by primary care centers, general practioners, primary care physicians or family physicians to treat patients. The generic healthcare data category 206, for example, may include generic healthcare records on common chronic diseases, such as, hypertension, diabetes, asthma, depression, anxiety, back pain, arthritis, basic maternal, vaccination, viral, and the like. The layered data structure 200 further includes the specialization healthcare data category 208. The term “specialization healthcare data category” refers to specialized healthcare data records that are required by specialized healthcare service providers to treat a patient. For example, healthcare records that are required by specialized healthcare providers or doctors, such as, cardiologists and gynecologists, for example, may be categorized as specialization healthcare data category. In an embodiment, the specialization healthcare data category 208 may include sub specialization data categories 210, 212. Each of the sub-specialization data categories 210, 212 may include healthcare data for a specific specialized data category. For example, the sub-specialization data category 210 may include healthcare records related to cardiology.

Furthermore, the layered data structure 200 includes an emergency data category 214 that stores emergency data of patients. As used herein, the term “emergency data” refers to emergency healthcare data that is required during emergency healthcare conditions for providing treatment to a patient. The emergency data, for example, includes a unique identification number, a social security number, insurance provider's name and contact details, identification details, relatives' name and contact details, blood group, allergies, and the like of a patient. It may be noted that the emergency data category 214 is coupled to each of the data categories 202, 204, 206, 208. Therefore, when one or more of the data categories 202, 204, 206, 208 are accessed, the emergency data category 214 may be accessed as a portion of one or more of the data categories 202, 204, 206, 208.

In the presently illustrated embodiment, the layered data structure 200 facilitates grant of selective and flexible reviewing, updating, and accessing rights to different stakeholders in the healthcare record system 10. For example, a healthcare worker may be granted rights to access, review and update the feedback data category 202 and socio-economic condition data category 204. Similarly, a generic healthcare service provider, such as, a general physician may be granted rights to access, review and update the feedback category 202, socio-economic condition data category 204 and generic healthcare data category 206. Furthermore, a specialized healthcare service provider, such as, a cardiologist may be granted rights to access, review and update one or more of the specialized sub-categories 210, 212 in the specialization healthcare data category 208. In certain embodiments, accessing and reviewing rights of the layered data structure 200 may be granted to each stakeholder, however, updating rights may be granted to selected stakeholders. For example, a general physician may have access to each of the data categories, however, may not have rights to update the specialization healthcare data categories 208. In an embodiment, the processing subsystems 12 referred to in FIG. 1 may grant the rights to the healthcare service providers 14, 16, 18, 20 to access, review and update the layered data structure 200.

In certain embodiments, the layered data structure 200 may be coupled to a connected records data category 220. The connected records data category 220 includes data that links historical health records and socio-economic condition records of a patient A with historical health records and socio-economic condition records of family members of the patient A in the layered data structure 200. The data that links historical health records and socio-economic condition records of the patient A with historical health records and socio-economic condition records of family members of the patient A, for example, may include identification details of the patient A and family members, location of historical health records and socio-economic condition records of the patient A and family members in a data repository. Therefore, when the healthcare service provider 16 views or retrieves the historical health records and socio-economic condition records of the patient A, the healthcare service provider 16 may review the historical health records and socio-economic condition records of the family members of the patient A. Consequently, the connected records data category 220 may facilitate the healthcare service providers 14, 16, 18, 20 to identify whether a disease is a genetic disease or an acquired disease. It is noted that while in the presently contemplated configuration, the connected records data category 220 is shown outside the layered data structure 200, in certain embodiments, the connected records data category 220 may be a category in the layered data structure 200.

FIG. 3 is a diagrammatic illustration of the health card 36 referred to in FIG. 1, in accordance with an exemplary embodiment of the present systems and techniques. In an embodiment, the health card 36 is a universal serial bus device (USB). As previously noted with reference to FIG. 1, the health card 36 stores the patient data 32. The health card 36 stores the patient data 32 in two categories including the emergency data category 214 (also referred to in FIG. 2) and a non-emergency data category 302. The emergency data category 214 stores emergency data. As previously noted with reference to FIG. 1, the term “emergency data” is used herein to refer to emergency healthcare data that is required during emergency healthcare condition for providing treatment to a patient. The emergency data category 214, for example, includes data, such as, identification details, blood group, allergies, and the like of the patient 30. The non-emergency data category 302 stores non-emergency data. As previously noted, the term “non-emergency data” is used herein to refer to healthcare records that may or may not be required during emergency condition of a patient. In certain embodiments, the non-emergency data category 302 corresponding to a patient, for example, may include data that is a subset or is similar to the data that is stored in the healthcare worker data category 202, socio-economic healthcare data category 204, generic healthcare data category 206 and the specialization healthcare data category 208 (referred to in FIG. 2) corresponding to the patient 30. Furthermore, the non-emergency data category 302, for example includes socio-economic information, health problems, diagnosed disease, suggested treatment, suggested medical checkups and medicines, health history, and the like of the patient 30.

The health card 36 further includes a card application 304 that retrieves and displays the patient's data 32 in a predefined format. Furthermore, the card application 304 displays the patient's data 32 in the predefined format of a display device, such as, the display device 29, 31. In an embodiment, the card application 304 is a software module that is coded in a hypertext markup language (HTML), SQLite, extensible markup language (XML), or combinations thereof. It is noted that the card application 304 displays the patient's data 32 in a predefined format irrespective of the operating system and hardware configuration of a processing subsystem. Furthermore, the card application 304 includes an authorization module 306 that entails authorization of the patient 30 before displaying the patient's data 32. The authorization of the patient, for example, may include submission of a password by the patient 30 for accessing the patient's data 32. It is noted that the card application 304 displays data in the emergency data category 214 without authorization. Therefore, during an emergency, the data in the emergency data category 214 can be reviewed by a stranger to the patient 30 for identifying and treating the patient 30. For example, the card application 304 may be used for retrieving the blood group and identification details of the patient 30.

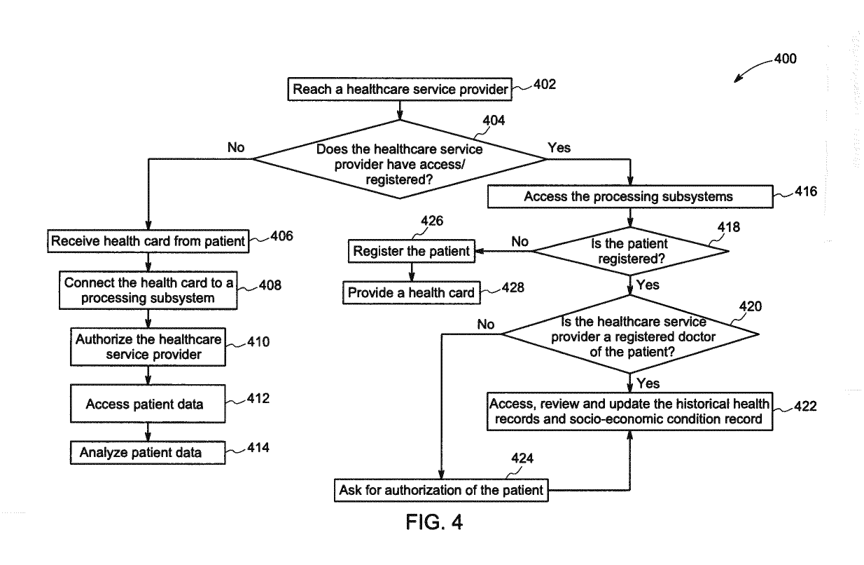

FIG. 4 is a flow chart that illustrates an exemplary method 400 for registering a patient with the plurality of processing subsystems 12, in accordance with certain aspects of the present techniques. Furthermore, in certain embodiments, the method 400 includes steps for accessing, retrieving and updating the historical health records and socio-economic condition records 13 in the processing subsystems 12. At step 402, a patient, such as, the patient 30 reaches a healthcare service provider. The healthcare service provider, for example, may include the healthcare service providers 14, 16, 18, 20. Furthermore, at step 404, a check may be carried out to verify whether the healthcare service provider is registered with the processing subsystems 12. At the step 404, when it is verified that the healthcare service provider is not registered with the processing subsystems 12, processing continues to step 406. At step 406, the healthcare service provider may receive a health card, such as, the health card 36 of the patient. As previously noted, the health card includes patient data of the patient. For example, when the patient is the patient 30, the health card 36 corresponding to the patient 30 includes the patient data 32. Furthermore, at step 408, the healthcare service provider may connect the health card to a respective processing device. At step 410, the healthcare service provider requests the patient to authorize the healthcare service provider to access the patient data in the health card. The patient, for example, may authorize the healthcare service provider by inserting a password in a processing device of the healthcare service provider to access the patient data in the health card. Moreover, at step 412, the healthcare service provider may access the patient data after authorization of the patient. At step 414, the healthcare service provider may analyze the patient data in the health card.

Referring back to step 404, when it is determined that the healthcare service provider is registered with the processing subsystems 12, processing continues to step 416. At step 416, the healthcare service provider accesses the processing subsystems 12. The healthcare service provider, for example, may access the processing subsystems by inserting respective identification number and password. The healthcare service provider, for example may insert the respective identification number and password through respective HSP processing subsystems in the processing subsystems 12. At step 418, a check may be carried out to determine whether the patient is registered with the processing subsystems 12. At step 418, when it is determined that the patient is registered with the processing subsystems 13, the processing continues to step 420. At step 420, a check is carried out to determine whether the healthcare service provider is a registered healthcare service provider of the patient. As used herein, the term “registered healthcare service provider” may be used to refer to a healthcare service provider who has been authorized by the patient to retrieve historical health records and socio-economic condition records of the patient.

At step 420, when it is determined that the healthcare service provider is a registered healthcare service provider of the patient, processing continues to step 422. At step 422, the healthcare service provider may access review, retrieve and update historical health records and socio-economic condition records of the patient in the processing subsystems 12. However, at step 420, when it is determined that the healthcare service provider is not a registered healthcare service provider of the patient, then processing continues to step 424. At step 424, the patient may authorize the healthcare service provider to access the health records and socio-economic condition records of the patient. The patient, for example, may authorize the healthcare service provider by inserting a respective user identification number and password. Referring back to step 418, when it is determined that the patient is not registered with the processing subsystems 12, processing continues to step 426. At step 426, the patient may be registered with the processing subsystems 12. The patient may be registered with the processing subsystems by inserting patient data corresponding to the patient in the processing subsystems 12. The patient data, for example may be inserted in the processing subsystems via the HSP processing subsystem of the healthcare service provider. At step 428, the healthcare service provider may provide a health card including the patient data to the patient.

FIG. 5 is a diagrammatic illustration of the service modules 44 referred to in FIG. 1, in accordance with an exemplary embodiment of the present systems and techniques. As previously noted, the service modules 44 provide selective stakeholder services to various stakeholders. For example, the service modules 44 may provide a first set of stakeholder services to healthcare service providers, however the first set of stakeholder services may not be provided to the government. For example, a healthcare service provider A may receive analysis of the historical health records and socio-economic condition records 13 to determine various medical paths opted by healthcare service providers in the past to treat an illness, and a percentage of success in treating the illness by opting each of the medical paths. However, the government may not be able to receive the analysis of the historical health records and socio-economic condition records 13 to determine various medical paths opted by healthcare service providers in the past to treat an illness.

As shown in FIG. 5, the service modules 44 include a deidentification module 500, a healthcare service provider module 502, a patient service module 504 and a government service module 506. As used herein, the term “healthcare service provider module” refers to a module that provides certain stakeholder services to healthcare services providers. The deidentification module 500 erases identification details from the historical health records and socio-economic condition records 13 to generate intermediate historical health records and socio-economic condition records.

The service modules 44 include the healthcare service provider module 502 that is operationally coupled to the deidentification module 500. In an embodiment, the healthcare service provider module 502 may receive the intermediate historical health records and socio-economic condition records from the deidentification module 500. The healthcare service provider module 502, for example, may analyze the intermediate historical health records and socio-economic condition records 13 to generate statistical and analytical healthcare results. The statistical and analytical healthcare results, for example, may include statistics and analysis of treatment methods opted in the past for treating a disease, illness, or predefined medical symptoms, and success statistics for each of the treatment methods. For example, when a patient complains of sore throat and fever to a doctor, the doctor may generate statistics on patients who had the symptoms of sore throat with fever using the healthcare service provider module 502. In alternative embodiments, the healthcare service provider module 502 may determine a number of patients who showed determined medical symptoms, and were treated using a determined medicine. The healthcare service provider module 502 may also determine the success statistics of the medicine in treating the medical symptoms. For example, when a patient P is suffering from hypertension, and has been consuming a medicine ME₁, and a physician considers adding a new medicine ME₂, the healthcare service provider module 502 may generate statistics and impact of the intake of the new medicine ME₂ based upon historical health records and socio-economic condition records of patients who were suffering from hypertension and were consuming the medicine ME₁.

The healthcare service provider module 502 further enables a healthcare service provider to retrieve historical health records and socio-economic condition records corresponding to a patient from the historical health records and socio-economic condition records 13. Subsequent to retrieval of the historical health records and socio-economic condition records corresponding to the patient, the healthcare service provider module 502 may transmit the retrieved health records and socio-economic condition records to a mobile device or a registered e-mail account of the healthcare service provider, or a mobile device of the patient. In certain embodiments, the healthcare service provider module 502 may display the retrieved patient data on a display device, such as, display device 29, 31 by using web services in a HSP processing subsystem, such as, the HSP processing subsystems 24, 26, 28.

Furthermore, the service modules 44 may include the patient service module 504. The patient service module 504 may provide selective stakeholder services to a patient, such as the patient 30. As used herein, the term “patient service module” refers to a module that provides certain stakeholder services to patients. Hereinafter, the terms “selective stakeholder services to a patient” and “patient services” shall be used interchangeably. The patient services, for example, may include retrieving and sending historical health records and socio-economic condition records corresponding to a patient, generating and sending life management guidelines to the patient, details of available healthcare services in a predefined region, details of available healthcare service providers in a predefined region, and the like. In certain embodiments, the patient service module 504 may send the life management guidelines to a patient A based upon the analysis of past few days' or months' historical health records and socio-economic condition records corresponding to the patient A. For example, when past few days' or months' historical health records and socio-economic condition records corresponding to the patient A shows continuous high blood pressure of the patient, then the patient service module 504 may send certain life management guidelines to control high blood pressure of the patient A.

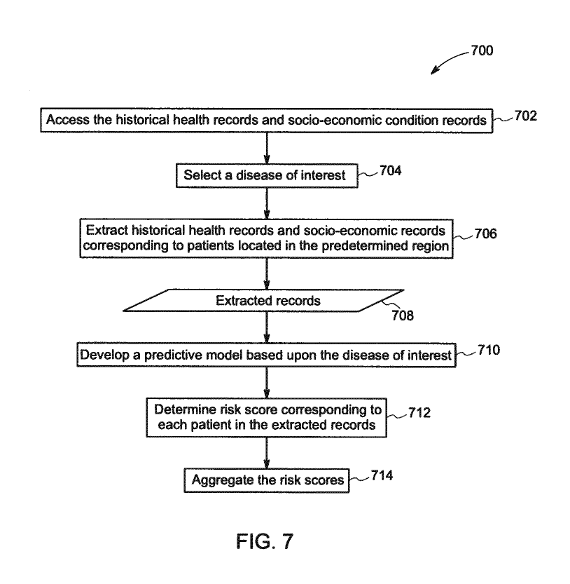

The service modules 44 include the government service module 506 that is operationally coupled to the deidentification module 500. The government service module 506 provides selective stakeholder services to the government. As used herein, the term “government service module” refers to a module that provides selective stakeholder services to patients. Hereinafter, the terms “stakeholder services to the government” and “government services” shall be used interchangeably. The government service module 506 may receive the intermediate historical health records and socio-economic condition records from the deidentification module 500. Furthermore, the government service module 506 may analyze the intermediate historical health records and socio-economic condition records to provide the government services. The government services, for example, may include statistical and analytical results on disease progression in predefined areas, statistical and analytical results on disease progression in predefined age group, gender, and the like. For example, when the government needs to decide healthcare budget for a predefined region, the government may be facilitated by the government service module 506 to generate statistics and analysis results based upon the requirements of the government. For example, the statistical and analytical results may include a percentage of people in the age group of 25-30 who suffered with cancer in a predefined region. Similarly, the statistical and analytical results may include a percentage increase in the number of patients of tumor with respect to patient of tumor in last year. In certain embodiments, the government service module 506 may predict a potential increase in a number of patients in forthcoming years in a predefined region or category. The predefined category, for example, may include an age group, gender, name of the disease, and the like. The government service module 506 may predict the potential increase in the number of patients in forthcoming years by analyzing the historical health records and socio-economic condition records 13. In certain embodiments, the government service module 506 may apply predictive modeling methods to predict the potential increase in number of patients in forthcoming years. The predictive modeling methods, for example, may include genetic methods, neural networks, logistic regression methods, Bayesian belief method, or the like. An exemplary method for predicting a potential increase in a disease or number of patients in a predefined region is explained in FIG. 7.

FIG. 6 is a flow chart that illustrates an exemplary method 600 for generating statistical and analytical results 612 by the healthcare service provider module 502 in FIG. 5. The statistical and analytical results 612 include statistics or analysis of treatment methods opted in the past by healthcare service providers, such as the healthcare service providers 14, 16. At step 602, a healthcare service provider may access the processing subsystems 12. As previously noted, the healthcare service provider may access the processing subsystems 12 by inserting respective user identification number or name and password in the processing subsystems 12. The user identification number or name and password of the healthcare service provider, for example, may be inserted using respective HSP processing subsystems, such as, the HSP processing subsystems 24, 26, 28. At step 604, symptoms of an illness or a disease observed in a patient may be entered by the healthcare service provider. The symptoms, for example, may be entered in the processing subsystems 12 through a healthcare service provider's processing subsystem, such as, the HSP processing subsystems 24, 26, 28. At step 606, a subset of the historical health records and socio-economic condition records 13 may be extracted. The subset of the historical health records and socio-economic condition records 13 includes patient data of a subset of patients who showed the symptoms of disease that have been entered in step 604. Furthermore, at step 608, treatment methods opted for the extracted subset of patients, effects of the treatment methods and health state of the subset of patients after going through the treatment methods may be extracted. Subsequently, at step 610, the statistical and analytical results 612 may be generated. The statistical and analytical results, for example, may be generated by analyzing the extracted treatment methods opted for the subset of patients, effects of the treatment methods and health state of the subset of patients.

FIG. 7 is a flow chart that illustrates an exemplary method 700 for predicting future trend of disease, in accordance with certain aspects of the present techniques. In an embodiment, the method 700 predicts a potential number of patients having a disease of interest in a predetermined region. At step 702, the historical health records and socio-economic condition records 13 may be accessed by the government service module 506. At step 704, a disease of interest may be selected. The disease of interest, for example, may be a disease for which the government requires statistical and analytical results. The disease of interest, for example, may be selected by a user or the government service module 506. It is noted that while the presently contemplated configuration describes prediction of a potential number of patients having the disease of interest, the method 700 may be used for predicting a potential number of patients having any disease.

In an embodiment, at step 706, when the government service module 506 predicts a potential number of patients in a predetermined region, the government service module 506 may extract historical health records and socio-economic condition records corresponding to patients located in the predetermined region from the historical health records and socio-economic condition records 13. In certain embodiments, when the government service module 506 predicts a potential number of patients having the disease of interest in a predetermined age group or a predetermined gender, the government service module 506 may extract historical health records and socio-economic condition records corresponding to patients having the predetermined age group or the predetermined gender from the historical health records and socio-economic condition records 13. In alternative embodiments, the government service module 506 extracts historical health records and socio-economic condition records corresponding to patients who do not have the disease of interest. The extraction of the historical health records and socio-economic condition records results in generation of extracted records 708.

Furthermore, at step 710 a predictive model may be developed by the government service module 708. The predictive model, for example may be developed based upon the disease of interest and using one or more predictive modeling methods. The predictive modeling methods, for example, include genetic methods, neural networks, logistic regression methods, Bayesian belief method, or the like.

At step 712, a risk score corresponding to each patient in the extracted records 708 may be determined by solving the predictive model and the extracted records 708. For example, the predictive model may be solved by inserting symptoms or medical tests outcome of each patient in the extracted records 708 in the predictive model. As used herein, the term “risk score” refers to a probability of a patient of having a disease of interest in future. Furthermore, at step 714, the risk scores that have been determined at step 712 may be aggregated. The aggregation of the risk scores, for example, may include taking an average of the risk scores, selecting one of the risk scores having the highest instances, taking a median of the risk scores, or the like. The aggregation of the risk scores results in determination of an aggregated risk score corresponding to the predetermined region, or age group or gender that may have the disease of interest. The aggregated risk score, for example, may enable the government to handle the future trend of the disease of interest in all geographic areas, genders or age group. For example, if the aggregate score of region R1 is higher than that of R2, it shows that the disease of interest is going to be a bigger problem in R1 than in R2 and hence the government may allocate higher budget for the region R1.

Certain embodiments of the present system and techniques provide portable health record system that electronically maintains health record information of an individual's lifetime health status, diseases and treatments. The portable health record system contains healthcare details of an individual's clinical encounters over his or her lifetime. Furthermore, certain embodiments of the present system and techniques offer a centralized health record system that is accessible to the patient and other healthcare providers with the authorization of the patient. Therefore, the centralized health record system may reduce redundancies in medication, medication errors, increase charting legibility, reduce documentation time, improve workflow management and reduce data retrieval time. Additionally certain embodiments of the present system and techniques provide selective stakeholder services to various stakeholders.

It is to be understood that not necessarily all such objects or advantages described above may be achieved in accordance with any embodiment of the present invention. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A system, comprising:
a data repository comprising historical health records and socio-economic condition records of a plurality of patients; and
a plurality of processing subsystems that are operationally coupled to the storage device, wherein the plurality of processing subsystems comprise two or more service modules that are configured to provide selective stakeholder services to one or more of a plurality of stakeholders based upon a plurality of parameters.

2. The system of claim 1, wherein the plurality of processing subsystems provide the selective stakeholder services by analyzing the historical health records and socio-economic condition records of the plurality of patients.

3. The system of claim 1, wherein the plurality of processing subsystems have a cloud computing architecture.

4. The system of claim 1, wherein the plurality of parameters comprise registration of a stakeholder with the plurality of processing subsystems, category of a stakeholder, rights and privileges of a stakeholder granted by the plurality of processing subsystems, or combinations thereof.

5. The system of claim 1, wherein the service modules comprise a healthcare service provider module, a patient service module, a government service module, a deidentification module, or combinations thereof.

6. The system of claim 5, wherein the deidentification module is configured to generate intermediate historical health records and socio-economic condition records by erasing identification details of the plurality of patients from the historical health records and socioeconomic records.

7. The system of claim 6, wherein the healthcare service provider module is configured to analyze the intermediate historical health records and socio-economic condition records to generate statistical and analytical healthcare results.

8. The system of claim 7, wherein the statistical and analytical healthcare results comprise statistics and analysis of previous treatment methods for predefined health symptoms, respectively, success statistics of each of the treatment methods, or combinations thereof.

9. The system of claim 5, wherein the healthcare service provider module is further configured to:
retrieve historical health records and socio-economic condition records corresponding to a patient from the historical health records and socio-economic condition records; and
transmit the historical health records and socio-economic condition records to a user end.

10. The system of claim 9, wherein the user end comprises a mobile device of a patient, a healthcare service provider's processing device, an e-mail identification of the patient, or combinations thereof.

11. The system of claim 5, wherein the patient service module is configured to:
extract historical health records and socio-economic condition records corresponding to a patient in the plurality of patients from the historical health records and socio-economic condition records of the plurality of patients;
analyze the extracted historical health records and socio-economic condition records corresponding to the patient in the plurality of patients to generate life management guidelines; and
transmit the life management guidelines to one of a mobile device or an e-mail account of the patient.

12. The system of claim 5, wherein the patient service module is further configured to retrieve and transmit historical health records and socio-economic condition records corresponding to a patient, transmit details of available healthcare services in a predefined region, details of available healthcare service providers in a predefined region, or combinations thereof.

13. The system of claim 6, wherein the government service module is configured to:
receive the intermediate historical health records and socio-economic condition records from the deidentification module; and
analyze the intermediate historical health records and socio-economic condition records to generate statistical and analytical results on disease progression in predefined areas, predefined age group, gender, or combinations thereof.

14. The system of claim 6, wherein the government service module is further configured to predict a potential number of patients or a disease in a defined region.

15. A method of generating statistical and analytical results, comprising:
entering symptoms of a disease in a plurality of processing subsystems by a healthcare service provider module;
extracting a subset of historical health records and socio-economic condition records from historical health records and socio-economic condition records of a plurality of patients;
extracting treatment methods and effects of the treatment methods from the subset of the historical health records and socio-economic condition records; and
generating the statistical and analytical results by analyzing the extracted treatment methods and effects of the treatment methods.

16. A method of predicting future trends of disease, comprising:
selecting a disease of interest by a government service module in a plurality of processing subsystems;
generating extracted records by extracting historical health records and socio economic condition records of patients who satisfy a predetermined condition in historical health records and socio-economic condition records corresponding to a plurality of patients;
developing a predictive model based upon the disease of interest utilizing a predictive modeling method;
determining a risk score corresponding to each patient in the extracted records by solving the predictive model; and
generating an aggregated risk score by aggregating the risk score corresponding to each patient in the extracted risk scores.

17. The method of claim 16, wherein the predetermined condition includes patients residing in a predetermined region, patients who belong to a predetermined age group, patients who belong to a predetermined gender, or combinations thereof.

18. The method of claim 16, wherein the predictive modeling method comprises genetic methods, neural networks, logistic regression methods, or Bayesian belief method.
